(19) United States
(12) Patent Application Publication
(10) Pub. No.: US 2025/0238637 A1
(43) Pub. Date: Jul. 24, 2025

(54) SYSTEM AND METHOD TO DEVELOP AND TRANSLATE LANGUAGE AGNOSTIC UNICODE PLATFORM WITH LARGE LANGUAGE MODELS ("LLM") FOR RENDERED PAGE LANGUAGE LEARNING AND LOCAL LLM CLIENTS

(71) Applicant: Bank of America Corporation, Charlotte, NC (US)

(72) Inventors: Saurabh Arora, Haryana (IN); Sandeep Kumar Chauhan, Hyderabad (IN)

(21) Appl. No.: 18/415,773

(22) Filed: Jan. 18, 2024

(51) Int. Cl. G06F 40/58; G06F 40/20

(52) U.S. Cl. CPC G06F 40/58; G06F 40/20

(57) ABSTRACT

Systems and methods are provided for categorizing a transfer target destination associated with a quick response (“QR”) code. An artificial intelligence (“AI”) engine may receive a plurality of recommendations for categorizing the transfer target destination. Each recommendation may be passed through a natural language processing (“NLP”) algorithm. Each recommendation may then be parsed by the AI engine to extract tag words. Each tag word may be mapped to a respective category. Each instance of each tag word and associated category may be stored in a database. The number of instances of each tag word and associated category may be counted. A percentage may be calculated for each category based on the number of instances associated with each category and the total number of instances of all the tag words.

### FIELD OF TECHNOLOGY

Aspects of the disclosure relate to technology for in situ language translation platforms.

### BACKGROUND OF THE DISCLOSURE

Applications are an ever-present part of our connected lives. Applications provide a variety of functions and services including, management and facilitating of email, web browsers, management of finances, planning of travel, fitness regimes and facilitating social media interactions. With the increase in globalism, application creators may desire to widen their consumer base and interactivity with their consumers. Application creators may desire to deploy their applications in multiple regions. Application creators may desire to deploy their applications for multiple groups of language speakers. Additionally, users may desire to translate pages rendered by applications into a preferred language.

Currently, in order to deploy applications in multiple languages, application creators may deploy multiple instances of the application. Each instance may include a deployment of the application in a distinct language. Each instance of the application may require separate application servers, separate development teams, and separate customer support. This may significantly raise the cost of deployment in multiple languages.

Another option that is currently in use for deploying applications in multiple languages is to include in app dynamic translation using in app supporting libraries. This may require large amounts of memory to store supporting libraries, code bundles and/or language packages. The supporting libraries, code bundles and/or language packages may need to be updated often to fixing bugs and provide updates to the libraries, bundles and/or packages. Frequent updates and reduced memory space on a user's device may be undesirable for the user. Frequent updates may require a team of developers to work on the updates. This may be expensive for the application creators to maintain.

Additionally, there are currently no user specific translation related plugins that a user can customize to the user's specific needs. There are currently no translation related plugins which can be used with multiple applications. There are currently no translation related plugins which can provide a translation for any language.

Therefore, it would be desirable to provide in app translations without requiring multiple instances of the application. It would be further desirable to provide translations without requiring supporting libraries, code bundles and/or language packages. It would be further desirable to provide user specific translation related plugins which can be customized to the user's specific needs. It would be further desirable to provide a translation related plugin which can be used with multiple applications. It would be further desirable to provide an agnostic Unicode platform plugin which can provide a translation for any language.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative apparatus in accordance with principles of the disclosure;

FIG. 2 shows another illustrative apparatus in accordance with principles of the disclosure;

FIG. 3 shows an illustrative flowchart in accordance with principles of the disclosure;

disclosure;

FIG. 4 shows an illustrative diagram in accordance with principles of the FIG. 5 shows another illustrative flowchart in accordance with principles of the disclosure;

FIG. 6 shows another illustrative diagram in accordance with principles of the disclosure; and

FIG. 7 shows another illustrative diagram in accordance with principles of the disclosure.

### DETAILED DESCRIPTION OF THE DISCLOSURE

Systems and methods are provided for rendering page translations in an application installed on a mobile device using a large language model (“LLM”) and an agnostic Unicode platform plugin.

The systems and methods may include providing an application on a device. The application may be a database, web-based, low code, no-code, enterprise, custom or any other suitable type of application. The device may be a computer, smart device, or any other suitable device which runs applications. The application may render pages on the device. The application may render images on the device. The pages or images may be in a first language. The application may communicate with an agnostic Unicode platform plugin.

The agnostic Unicode platform plugin may be integrated with the application. The agnostic Unicode platform plugin may be a separate application. The plugin may be stored on the device. The application may communicate a rendered page to the plugin. The application may communicate a rendered image to the plugin. The plugin may communicate with a large language model. The plugin may communicate with the large language model via the internet, a wired connection, a wireless connection or any other suitable connection. The large language model may be stored in an internet accessible server or the cloud. The large language model may be independent of the device.

The large language model may translate a page or image rendered in a first language into a second language. The page may be fed to the large language model from the agnostic Unicode platform plugin. The large language model may include a large agnostic model. The large agnostic model may render the translation. The large agnostic model may communicate the rendered translation back to the plugin. The plugin may communicate the rendered translation back to the application.

The large agnostic model may include artificial intelligence (“AI”) or machine learning (“ML”) engines. The AI engine may be trained to render translations. The large agnostic model may include a natural language processor (“NLP”). The NLP may parse the page or image for words. The NLP may be able to detect words from the page or image. The AI engine may translate the words detect by the NLP.

The AI engine may be trained to render translations. The training may include compiling language translation information relating to a plurality of languages. The language translation information may include translation dictionaries, language usage information, language syntax information and any other suitable information needed to translate the plurality of languages. The compilation of the language translation information may be stored in the large language model. The language translation information may be compiled from a plurality of sources. The plurality of sources may include the internet, a private database or a private server.

The trained large agnostic model may be put into operation. Once in operation the large agnostic model may be connected to the plurality of sources. The large agnostic model may continuously update itself via the connection to the plurality of sources. The AI engine may self-learn updated language translation information via its connection to the plurality of sources. The AI engine may search for updated language translation information via the internet. The large agnostic model may operate independent of updates once in operation. The AI engine may search for new or updated language translation information independently.

The large language model may be fed language translation information for a plurality of languages. The language translation information may be fed to the large agnostic model. The plurality of languages may be predetermined during training. The plurality of languages may be selected by a user. Additional languages may be learned by the large language model. To learn an additional language the large language model may search for language translation information related to the additional language. The large language model may compile the language translation information related to the additional language. The large language model may feed the compiled language translation information related to the additional language to the large agnostic model to be utilized and stored.

The large language model may learn new languages when they become available on the plurality of sources. The large language model may learn new languages based on a user selection. The large language model may learn new languages based on emerging properties. The emerging properties may include a location of the device, changing user language preferences and/or information unique to the page or image from the application. For example, when the device is brought to a province in China, the large language model may automatically learn the main languages of that location.

The AI engine may monitor the user device for user language preferences. The AI engine may detect a user language preference. The AI engine may detect the user employing words or phrases in a new language. The AI engine may determine the new language. The AI engine may learn the new language.

The page or image fed to the large language model may include languages which the large language model does not understand. The NLP and AI engine may search for the language which the large language model does not understand. The large language model may then proceed to learn that language. The large language model may learn the new language independent of downloading or installing additional files on the device. The large language model may learn the new language without supporting libraries, code bundles and/or language packages.

The agnostic Unicode platform plugin may be customized by the user. The user may select which languages the plugin should learn. The user may select the language into which the plugin renders the translation. The plugin may be compatible with a specific application. The plugin may be compatible with many applications. The plugin may be a separate application accessible on the user device. The plugin may be integrated with another application. The user may select where to store the plugin. The plugin may communicate with other applications. For example, the plugin may relay the rendered translation to a text to speech application. The text to speech application may read the rendered translation out loud.

The agnostic Unicode platform plugin may automatically provide a rendered translation of an application page or image. The agnostic Unicode platform plugin may provide a rendered translation of an application page or image upon a user request. The agnostic Unicode platform plugin may be integrated into the application. The application may communicate with an application server to retrieve pages or images. The plugin may determine the emerging properties. The plugin may automatically render the page into the translated page on the user's device. For example, the application may communicate with the application server via an IP address. The IP address may belong to a location in France. The plugin may automatically render the retrieved page in French without first rendering the page in its original language.

The plugin may provide a rendered translation upon a user request. The plugin may provide a prompt when the user opens a page in an application. The prompt may ask the user whether a translation is required. The plugin may provide a rendered translation based on a user response to the prompt. The user may request to translate the page into a language the user does not understand. For example, the user may write an email in English to be sent to a colleague that only understands Mandarin. The user may request the plugin translate the email into Mandarin. The user may send the translated email to the colleague.

The agnostic Unicode platform plugin may be used partially within an application. For example, a user may be able to highlight a word or phrase in the application and the plugin will provide a translation of the highlighted word or phrase in the application. The translation may replace the word or phrase in the application. The translation may be placed above or below the word or phrase in the application. The translation may be rendered in a different color, font or size to differentiate it from the original word or phrase.

The AI engine may adapt itself to the user's preferences. The AI engine may learn when the user desires translations based on the user's past actions. The AI engine may learn what language the user prefers. The user may prefer different languages in different circumstances. For example, when in China the user may prefer pages to be translated into Mandarin and when in the United States the user may prefer pages to be translated into English.

The AI engine may learn the user's syntax. The AI engine may monitor the user's syntax. The AI engine may integrate the user's syntax into rendered translations. This may make the rendered translation easier for the user to understand. The syntax of the user may change over time. The AI engine may continuously monitor the user's syntax. The AI engine may adapt to the changing user syntax. For example, the user's syntax may indicate whether the user prefers American English vs British English or some other variation.

The AI engine may monitor the user's past actions for catch words. Catch words may be words the user always writes in a specific language. For example, when writing an email in Mandarin the user may include catch words in the email which are written in English. The AI engine may learn the catch words. The AI engine may render every instance of the catch word in the preferred language in rendered translations. For example, when the plugin renders a page originally in French into Mandarin the plugin may render each catch word into English.

The user may be able to help the AI engine learn. The user may be able to comment on the quality of the rendered translation. The user may be able to correct a mistranslation. The user may be able to note where a translation is illogical. The AI engine may use the comments, corrections and notes to update the large language model.

The agnostic Unicode platform plugin may require a round-trip with the large language model to provide a rendered translation. The round-trip may require an internet connected device. The round-trip may require an internet connection. The round-trip may take time to complete. The user may desire a lightweight language model installed on the user device to increase the speed of rendering a translation. The user may desire a lightweight language model installed on the user device where an internet connection is unavailable.

A lightweight language model may be installed on a user device. The lightweight language model may be integrated with an application. The lightweight language model may be a separate application. The lightweight language model may render translations. The lightweight language model may include a compilation of language translation information relating to a plurality of languages. The compilation may be compiled in a similar manner as described above with respect to the large language model. The plurality of languages may be selected by the user. The plurality of languages may be languages that are most used by the user. The plurality of languages may be preprogrammed into the lightweight language model before installation in the user device. The plurality of languages may be programmed into the lightweight language model after installation in the user device. The lightweight language model may communicate with the large language model. The lightweight language model may feed pages with languages other than the plurality of languages to the large language model for rendering translations in a similar manner to the agnostic Unicode platform plugin described above.

The lightweight language model may be able to provide on the go translations without making round-trips to the large language model. The lightweight language model may render translation in a similar manner to the large language model discussed above. The lightweight language model may require updates. The lightweight language model may receive updates from the large language model relating to the plurality of languages. The lightweight language model may update upon a user request. The lightweight language model may update when an internet connection is available. The lightweight language model may update periodically. The update periods may be every day, week, 10 days, month or any suitable period of time.

The user may select the plurality of languages. The user may select the plurality of languages based on user preference, memory available on the user device or based on current needs. The user may remove languages from the plurality of languages to increase the amount of free space on the user device. The user may request languages be added to the plurality of languages. Language translation information relating to the added languages may be compiled similar to the compilations described above. The compilation may be downloaded to the lightweight language model.

The lightweight language model may include an AI engine or ML engine. The AI engine included in the lightweight language model may be similar to the AI engine described above. The AI engine included in the lightweight language model may include all the features described with respect to the AI engine described in detail above.

One of ordinary skill in the art will appreciate that the steps shown and described herein may be performed in other than the recited order and that one or more steps illustrated may be optional. Apparatus and methods may involve the use of any suitable combination of elements, components, method steps, computer-executable instructions, or computer-readable data structures disclosed herein.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Illustrative embodiments of apparatus and methods in accordance with the principles of the invention will now be described with reference to the accompanying drawings, which form a part hereof. It is to be understood that other embodiments may be utilized, and that structural, functional, and procedural modifications may be made without departing from the scope and spirit of the present invention.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

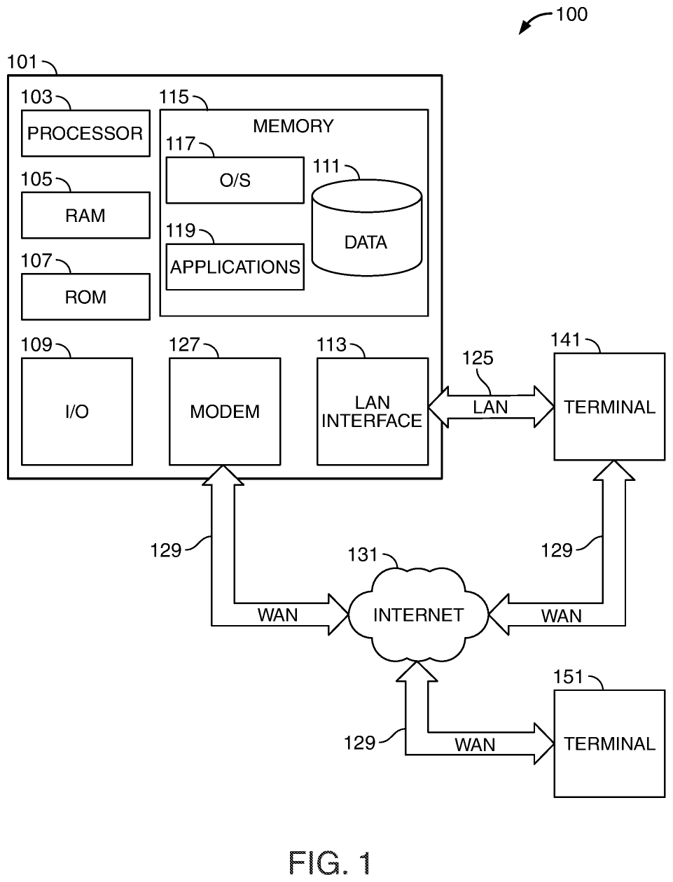

In accordance with principles of the disclosure, FIG. 1 shows an illustrative block diagram of apparatus 100 that includes a computer 101. Computer 101 may alternatively be referred to herein as a “computer system” or “computing device.” Elements of apparatus 100, including computer 101, may be used to implement various aspects of the systems and method disclosed herein. A “user” of apparatus 100 or computer 101 may include other computer systems or servers or computing devices, such as the program described herein.

Computer 101 may have one or more processors/microprocessors 103 for controlling the operation of the device and its associated components, and may include RAM 105, ROM 107, input/output module 109, and a memory 115. The microprocessors 103 may also execute all software running on the computer 101, e.g., the operating system 117 and applications 119 such as an automatic data layering program and security protocols. Other components commonly used for computers, such as EEPROM or Flash memory or any other suitable components, may also be part of the computer 101.

The memory 115 may be comprised of any suitable permanent storage technology—e.g., a hard drive or other non-transitory memory. The ROM 107 and RAM 105 may be included as all or part of memory 115. The memory 115 may store software including the operating system 117 and application(s) 119 (such as an automatic data layering program and security protocols) along with any other data 111 (e.g., historical data, configuration files) needed for the operation of the apparatus 100. Memory 115 may also store applications and data. Alternatively, some or all of computer executable instructions (alternatively referred to as “code”) may be embodied in hardware or firmware (not shown). The microprocessor 103 may execute the instructions embodied by the software and code to perform various functions.

The network connections/communication link may include a local area network (LAN) and a wide area network (WAN or the Internet) and may also include other types of networks. When used in a WAN networking environment, the apparatus may include a modem or other means for establishing communications over the WAN or LAN. The modem and/or a LAN interface may connect to a network via an antenna. The antenna may be configured to operate over Bluetooth, wi-fi, cellular networks, or other suitable frequencies.

Any memory may be comprised of any suitable permanent storage technology—e.g., a hard drive or other non-transitory memory. The memory may store software including an operating system and any application(s) (such as an automatic data layering program and security protocols) along with any data needed for the operation of the apparatus and to allow bot monitoring and IoT device notification. The data may also be stored in cache memory, or any other suitable memory.

An input/output (“I/O”) module 109 may include connectivity to a button and a display. The input/output module may also include one or more speakers for providing audio output and a video display device, such as an LED screen and/or touchscreen, for providing textual, audio, audiovisual, and/or graphical output.

In an embodiment of the computer 101, the microprocessor 103 may execute the instructions in all or some of the operating system 117, any applications 119 in the memory 115, any other code necessary to perform the functions in this disclosure, and any other code embodied in hardware or firmware (not shown).

In an embodiment, apparatus 100 may consist of multiple computers 101, along with other devices. A computer 101 may be a mobile computing device such as a smartphone or tablet.

Apparatus 100 may be connected to other systems, computers, servers, devices, and/or the Internet 131 via a local area network (LAN) interface 113.

Apparatus 100 may operate in a networked environment supporting connections to one or more remote computers and servers, such as terminals 141 and 151, including, in general, the Internet and “cloud”. References to the “cloud” in this disclosure generally refer to the Internet, which is a world-wide network. “Cloud-based applications” generally refers to applications located on a server remote from a user, wherein some or all the application data, logic, and instructions are located on the internet and are not located on a user's local device. Cloud-based applications may be accessed via any type of internet connection (e.g., cellular or wi-fi).

Terminals 141 and 151 may be personal computers, smart mobile devices, smartphones, IoT devices, or servers that include many or all the elements described above relative to apparatus 100. The network connections depicted in FIG. 1 include a local area network (LAN) 125 and a wide area network (WAN) 129 but may also include other networks. Computer 101 may include a network interface controller (not shown), which may include a modem 127 and LAN interface or adapter 113, as well as other components and adapters (not shown). When used in a LAN networking environment, computer 101 is connected to LAN 125 via a LAN interface or adapter 113. When used in a WAN networking environment, computer 101 may include a modem 127 or other means for establishing communications over WAN 129, such as Internet 131. The modem 127 and/or LAN interface 113 may connect to a network via an antenna (not shown). The antenna may be configured to operate over Bluetooth, wi-fi, cellular networks, or other suitable frequencies.

It will be appreciated that the network connections shown are illustrative and other means of establishing a communications link between computers may be used. The existence of various well-known protocols such as TCP/IP, Ethernet, FTP, HTTP, and the like is presumed, and the system can be operated in a client-server configuration. The computer may transmit data to any other suitable computer system. The computer may also send computer-readable instructions, together with the data, to any suitable computer system. The computer-readable instructions may be to store the data in cache memory, the hard drive, secondary memory, or any other suitable memory.

Application program(s) 119 (which may be alternatively referred to herein as “plugins,” “applications,” or “apps”) may include computer executable instructions for an automatic data layering program and security protocols, as well as other programs. In an embodiment, one or more programs, or aspects of a program, may use one or more AI/ML algorithm(s). The various tasks may be related to analyzing and categorizing various data to layer the data according to levels of access.

Computer 101 may also include various other components, such as a battery (not shown), speaker (not shown), a network interface controller (not shown), and/or antennas (not shown).

Terminal 151 and/or terminal 141 may be portable devices such as a laptop, cell phone, tablet, smartphone, server, or any other suitable device for receiving, storing, transmitting and/or displaying relevant information. Terminal 151 and/or terminal 141 may be other devices such as remote computers or servers. The terminals 151 and/or 141 may be computers where a user is interacting with an application.

Any information described above in connection with data 111, and any other suitable information, may be stored in memory 115. One or more of applications 119 may include one or more algorithms that may be used to implement features of the disclosure, and/or any other suitable tasks.

In various embodiments, the invention may be operational with numerous other general purpose or special purpose computing system environments or configurations. Examples of well-known computing systems, environments, and/or configurations that may be suitable for use with the invention in certain embodiments include, but are not limited to, personal computers, servers, hand-held or laptop devices, tablets, mobile phones, smart phones, other Computers, and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, IoT devices, and the like.

Aspects of the invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked via a communications network, e.g., cloud-based applications. In a distributed computing environment, program modules may be located in both local and remote computer storage media including memory storage devices.

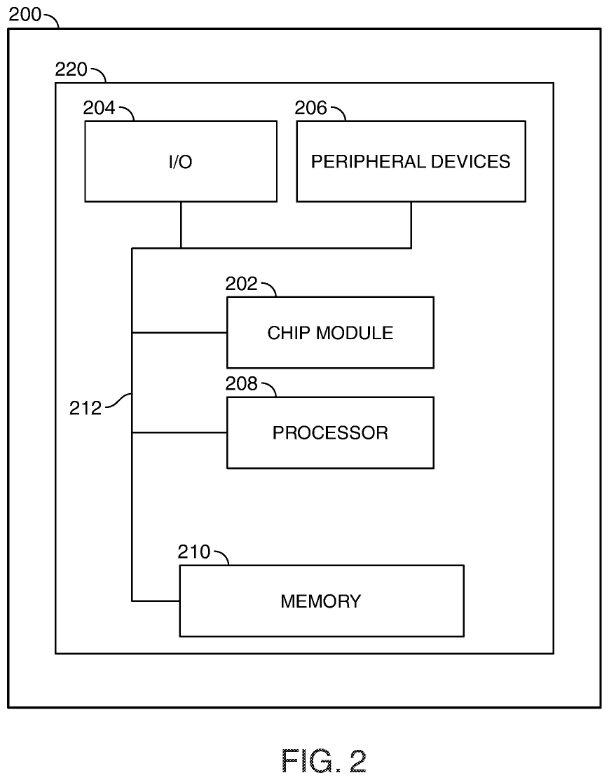

FIG. 2 shows illustrative apparatus 200 that may be configured in accordance with the principles of the disclosure. Apparatus 200 may be a server or computer with various peripheral devices 206. Apparatus 200 may include one or more features of the apparatus shown in FIGS. 1-6. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device, an display (LCD, LED, OLED, etc.), a touchscreen or any other suitable media or devices; peripheral devices 206, which may include other computers; logical processing device 208, which may compute data information and structural parameters of various applications; and machine-readable memory 210.

Machine-readable memory 210 may be configured to store in machine-readable data structures: machine executable instructions (which may be alternatively referred to herein as “computer instructions” or “computer code”), applications, signals, recorded data, and/or any other suitable information or data structures. The instructions and data may be encrypted.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

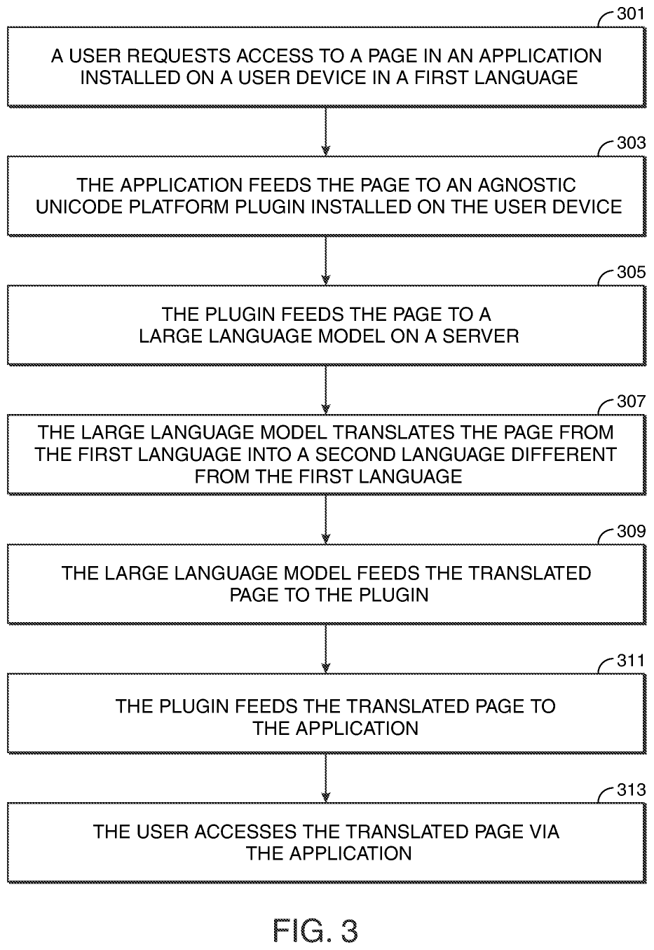

FIG. 3 shows an illustrative flowchart in accordance with principles of the disclosure. At step 301, methods may include a user requesting access to a page in an application installed on a user device in a first language. The page may be a webpage, an email, an image with words written on it, or any other suitable page. At step 303, methods may include the application feeding the page to an agnostic Unicode platform plugin installed on the user device. At step 305, methods may include the plugin feeding the page to a large language model on a server. At step 307, methods may include the large language model translating the page from the first language into a second language different from the first language.

At step 309, methods may include the large language model feeding the translated page back to the plugin. At step 311, methods may include the plugin feeding the translated page back to the application. At step 313, methods may include the user accessing the translated page via the application.

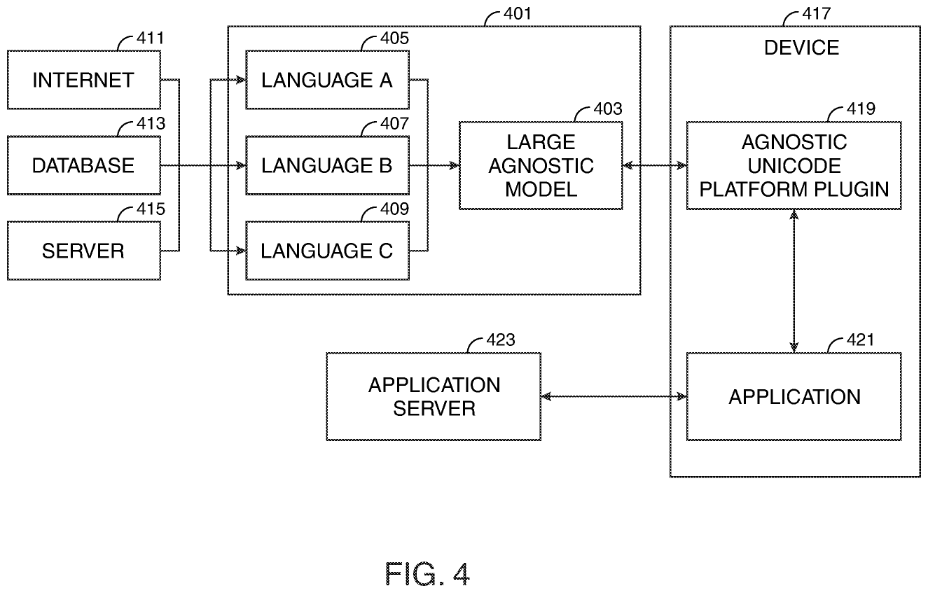

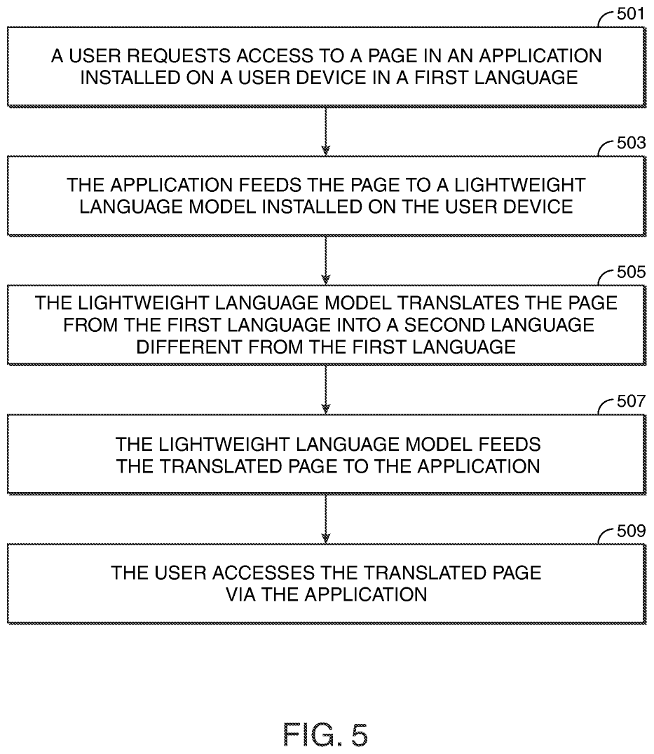

FIG. 4 shows an illustrative diagram in accordance with principles of the disclosure. Large language model 401 may include large agnostic model 403. Large agnostic model 403 may include an AI engine. Large language model 401 may receive language translation information 405, 407 and 409 for a language A, language B and language C respectively. Large language model 401 may receive language translation information 405, 407 and 409 from internet 411, database 413 and/or server 415. Large language model 401 may receive language translation information 405, 407 and 409 via a wired connection, an internet connection, a wireless connection or any other suitable connection.

Large language model 401 may be connected to device 417. Device 417 may include some or all the features of computer 101 and/or apparatus 200 described in detail above. Device 417 may include agnostic Unicode platform plugin 419 and application 421. Agnostic Unicode platform plugin 419 may be integrated with application 421. Agnostic Unicode platform plugin 419 may be separate from application 421. Agnostic Unicode platform plugin 419 may communicate with application 421. Device 417 may connect to large language model 401. Device 417 may be connected to large language model 401 via a wired connection, an internet connection, a wireless connection or any other suitable connection.

Application 421 may communicate with application server 423. Application 421 may communicate with application server 423 via a wired connection, an internet connection, a wireless connection or any other suitable connection. Application 421 may access a page through application server 423. Application 421 may feed the page to agnostic Unicode platform plugin 419. Agnostic Unicode platform plugin 419 may feed the page to large language model 401. Large language model 401 may translate the page and send it back to agnostic Unicode platform plugin 419. Agnostic Unicode platform plugin 419 may feed the translated page back to application 421 or to a different application on device 417.

FIG. 5 shows another illustrative flowchart in accordance with principles of the disclosure. At step 501, methods may include a user requesting access to a page in an application installed on a user device in a first language. The page may be a webpage, an email, an image with words written on it, or any other suitable page. At step 503, methods may include the application feeding the page to a lightweight language model on the use device. At step 505, methods may include the lightweight language model translating the page from the first language into a second language different from the first language.

At step 507, methods may include the lightweight language model feeding the translated page back to the application. At step 509, methods may include the user accessing the translated page via the application.

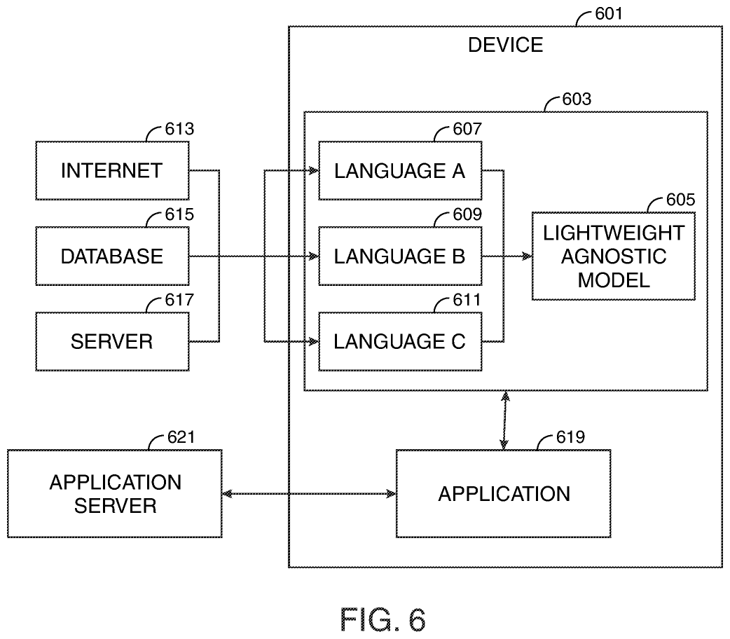

FIG. 6 shows another illustrative diagram in accordance with principles of the disclosure. Device 601 may include some or all the features of computer 101, apparatus 200 and/or device 417 described in detail above. Device 601 may include lightweight language model 603 and application 619. Lightweight language model 603 may include lightweight agnostic model 605. Lightweight agnostic model 605 may include an AI engine. Lightweight language model 603 may receive language translation information 607, 609 and 611 for a language A, language B and language C respectively. Lightweight language model 603 may receive language translation information 607, 609 and 611 from internet 613, database 615 and/or server 617. Lightweight language model 603 may receive language translation information 607, 609 and 611 via a wired connection, an internet connection, a wireless connection or any other suitable connection.

Application 619 may communicate with application server 621. Application 619 may communicate with application server 621 via a wired connection, an internet connection, a wireless connection or any other suitable connection. Application 619 may access a page through application server 621. Application 619 may feed the page to lightweight language model 603. Lightweight language model 603 may translate the page and send it back to application 619 or to a different application on device 601.

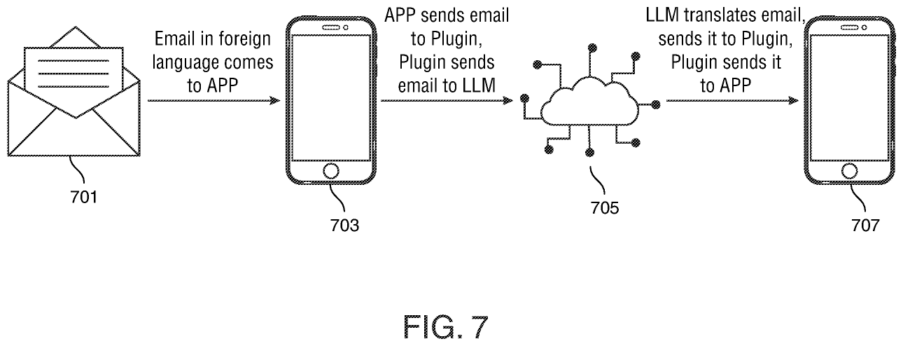

FIG. 7 shows another illustrative diagram in accordance with principles of the disclosure. Email 701 in a foreign language may come to an email application on device 703. A plugin on device 703 may send the text of the email to a large language model in cloud 705. The large language model may translate the text of the email. The large language model in cloud 705 may send the translated text back to the plugin on device 707. Device 707 may be the same as device 703. Device 707 may be separate from device 703. The plugin may send the translated text back to the email application to be viewed by the user.

Thus, systems and methods for SYSTEM AND METHOD TO DEVELOP AND TRANSLATE LANGUAGE AGNOSTIC UNICODE PLATFORM WITH LARGE LANGUAGE MODELS (“LLM”) FOR RENDERED PAGE LANGUAGE LEARNING AND LOCAL LLM CLIENTS have been provided. Persons skilled in the art will appreciate that the present invention can be practiced by other than the described embodiments, which are presented for purposes of illustration rather than of limitation, and that the present invention is limited only by the claims that follow.

What is claimed is:

1. A method for rendering page translations in an application installed on a mobile device using a large language model and an agnostic Unicode platform plugin, the method comprising:
training the large language model, the training comprising:
compiling, in a first compilation, first language translation information relating to a first plurality of languages from a plurality of sources;
storing the compilation in the large language model;
connecting the large language model to the plurality of sources; and
continuously updating the large language model via the connection to the plurality of sources, the continuous updating including refining the compilation;
connecting the agnostic Unicode platform plugin to the large language model;
rendering a page in the application in one of the first plurality of languages; and
translating the page into another of the first plurality of languages using the agnostic Unicode platform plugin, the translating for feeding a translation of the page from the large language model to the mobile device.

2. The method of claim 1 wherein the agnostic Unicode platform plugin automatically renders a translation of the page based on emerging properties, the emerging properties include location of the user device, user preferences, and/or information unique to the page.

3. The method of claim 1 wherein:
the plurality of sources includes the internet, private databases and/or private servers; and
the connection to the plurality of sources is via the internet or a wired connection.

4. The method of claim 1 wherein the application is independent of language specific: packages, libraries and/or code bundles to render translations.

5. The method of claim 1 wherein, upon a request, the large language model learns one or more second languages different from the first plurality of languages, the learning comprises:
compiling, in a second compiling step, language translation information relating to the one or more second languages from the plurality of sources;
storing the compilation of the second compiling step in the large language model.

6. The method of claim 5 wherein the learning of the one or more second languages is independent of downloading or installing additional files on the user device.

7. The method of claim 5 wherein a user selects the one or more second languages.

8. The method of claim 1 wherein a user selects the language in which the page is rendered.

9. The method of claim 1 wherein:
the large language model is stored in an internet accessible server or on the cloud; and
the agnostic Unicode platform plugin is installed on the user device.

10. A method for rendering page translations in an application installed on a mobile device using a large language model, the method comprising:
training the large language model, the training comprising:
compiling language translation information relating to a first plurality of languages from a plurality of sources;
storing the compilation in the large language model; and
installing the large language model on the mobile device;
updating the language translation information compiled for the large language model via a connection to the plurality of sources;
rendering, by the application, a page in the application in a first of the first plurality of languages; and
translating, by the large language model, the page into a second of the first plurality of languages;
wherein the plurality of sources includes the internet, private databases and/or private servers.

11. The method of claim 10 wherein the large language model includes an artificial intelligence (“AI”) engine, the AI engine:
monitors syntax the user uses on the mobile device; and
integrates the syntax into the translated page.

12. The method of claim 11 further comprising the AI engine rendering every instance of a catch word on the page into a third language of the first plurality of languages.

13. The method of claim 12 wherein the catch word is selected by the user.

14. The method of claim 12 wherein the catch word is selected by the AI engine.

15. The method of claim 10 wherein the application does not require language specific: packages, libraries and/or code bundles to render translations.

16. The method of claim 10 wherein, upon the user request, the large language model learns one or more second languages different from the first plurality of languages, the learning comprises:
compiling, in a second compiling step, language translation information relating to the one or more second languages from the plurality of sources;
downloading the compilation of the second compiling step to the large language model.

17. The method of claim 14 wherein a user selects the one or more second languages.

18. The method of claim 10 wherein a user selects the language in which the page is rendered.

19. The method of claim 10 wherein the updating is performed periodically or upon a user request.

20. A device for rendering page translations in an application installed on the device using a large language model, the device comprising:
a processor; and
a non-transitory computer-readable medium including instructions that when executed by the processor:
renders, by the application, a page in the application in one of a first plurality of languages;
translates, by the large language model, the page into another of the first plurality of languages; and
updates language translation information stored on the large language model via a connection to a plurality of sources;
wherein:
the large language model includes a compilation of language translation information relating to the first plurality of languages from the plurality of sources; and
the plurality of sources includes the internet, private databases and/or private servers.
